(19) United States
(12) Patent Application Publication
(10) Pub. No.: US 2019/0031115 A1
(43) Pub. Date: Jan. 31, 2019

(54) ATTACHMENT STRUCTURE OF DRIVING APPARATUS

(71) Applicant: DENSO TEN Limited, Kobe-shi (JP)

(72) Inventors: Masashi HIDA, Kobe-shi (JP); Tomohisa KOSEKI, Kobe-shi (JP); Masashi OTOMI, Kobe-shi (JP)

(73) Assignee: DENSO TEN Limited, Kobe-shi (JP)

(21) Appl. No.: 16/028,554

(22) Filed: Jul. 6, 2018

(30) Foreign Application Priority Data
Jul. 31, 2017 (JP) 2017-148564
Apr. 6, 2018 (JP) 2018-073811

(51) Int. Cl. B60R 11/02; G02B 27/00; B60S 1/56

(52) U.S. Cl. CPC B60R 11/0264; B60S 1/56; G02B 27/0006

(57) ABSTRACT

An attachment structure of a driving apparatus according to an embodiment includes an attachment part, a bracket, and an elastic member. The attachment part is provided in the driving apparatus. The bracket is erected on an attached member. An end close to the attached member of the elastic member is in contact with the attached member. At least a part of the elastic member is arranged between the attachment part and the bracket.

### CROSS-REFERENCE TO RELATED APPLICATION

This application is based upon and claims the benefit of priority of the prior Japanese Patent Application No. 2017-148564, filed on Jul. 31, 2017 and Japanese Patent Application No. 2018-073811, filed on Apr. 6, 2018, the entire contents of which are incorporated herein by reference.

### FIELD

The embodiments discussed herein are directed to an attachment structure of a driving apparatus.

### BACKGROUND

Conventionally, there has been known an attachment structure of a driving apparatus for attaching a housing provided with a motor to a bracket while interposing a rubber therebeween (see, e.g., Japanese Laid-open Patent Publication No. 2002-276978).

However, the above-mentioned attachment structure of the driving apparatus has room for improvement in suppressing transmission of vibration of the motor to the bracket. When the vibration of the motor is transmitted to the bracket, there exists possibility that an abnormal noise is generated due to vibration of the bracket.

### SUMMARY

An attachment structure of a driving apparatus according to an embodiment includes an attachment part, a bracket, and an elastic member. The attachment part is provided in the driving apparatus. The bracket is erected on an attached member. An end close to the attached member of the elastic member is in contact with the attached member. At least a part of the elastic member is arranged between the attachment part and the bracket.

### BRIEF DESCRIPTION OF DRAWINGS

FIG. 1 is a schematic diagram illustrating a rear portion of a vehicle;

FIG. 2 is schematic diagram illustrating a part of the inside of a rear hatch as viewed from the front;

FIG. 3 is a cross-sectional view of FIG. 2 taken along a line III-III;

FIG. 4 is a schematic cross-sectional view illustrating a part of an attachment structure of a driving apparatus according to a modification;

FIG. 5 is a schematic cross-sectional view illustrating a part of an attachment structure of the driving apparatus according to a modification;

FIG. 6 is a schematic diagram illustrating a part of an attachment structure of the driving apparatus according to a modification;

FIG. 7 is a schematic perspective view illustrating brackets used in an attachment structure of the driving apparatus according to a modification;

FIG. 8 is a cross-sectional view of FIG. 7 taken along a line VIII-VIII;

FIG. 9 is a cross-sectional view illustrating a driving apparatus according to a modification;

FIG. 10 is an enlarged cross-sectional view illustrating a part of an attachment structure of a driving apparatus according to a second embodiment;

FIG. 11 is a cross-sectional view illustrating an attachment structure of the driving apparatus according to a modification; and

FIG. 12 is a cross-sectional view illustrating an attachment structure of the driving apparatus according to a modification.

### DESCRIPTION OF EMBODIMENTS

Hereinafter, an attachment structure of a driving apparatus disclosed in the present application will be described in detail with reference to the accompanying drawings. Moreover, the embodiments described below are merely examples, and not intended to limit the present disclosure.

### First Embodiment

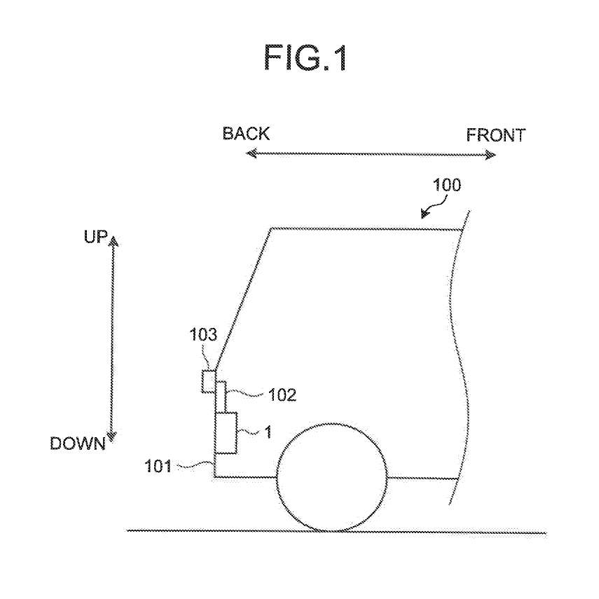

As illustrated in FIG. 1, an attachment structure of a driving apparatus according to a first embodiment is an attachment structure for attaching a pump 1 (driving apparatus) to a rear hatch 101 of a vehicle 100. Specifically, the attachment structure is a structure for attaching the pump 1 to an inner side of an outer panel of the rear hatch 101. FIG. 1 is a schematic diagram illustrating a rear portion of the vehicle 100. The pump 1 blows compressed air to a back camera 103 via a hose 102 and the like. Thus, the pump 1 removes an extraneous matter adhered to the back camera 103, such as a raindrop, by using the compressed air.

The attachment structure of the driving apparatus is not limited to that for attaching the driving apparatus to the rear hatch 101, and thus the driving apparatus may be a motor or the like, not limited to the pump 1.

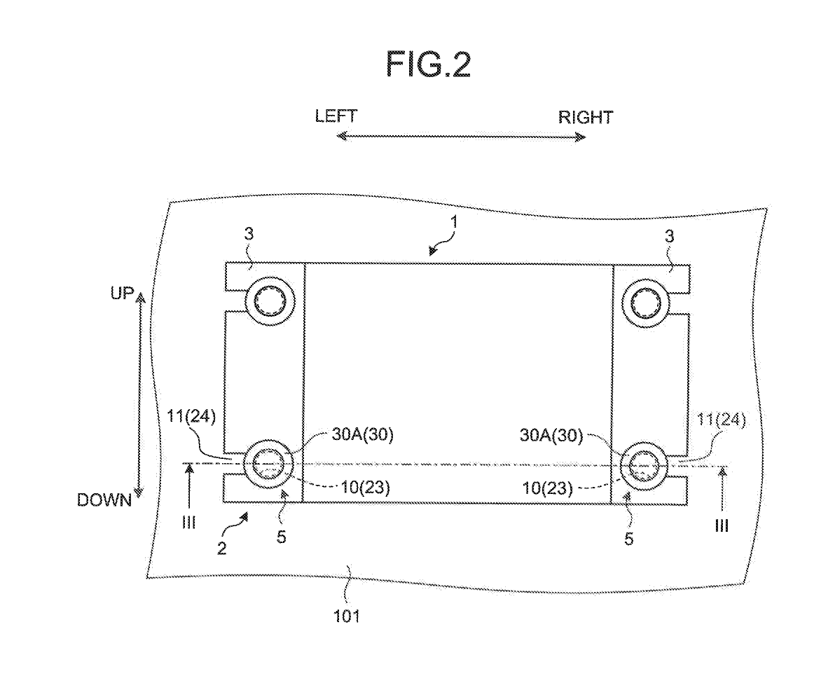

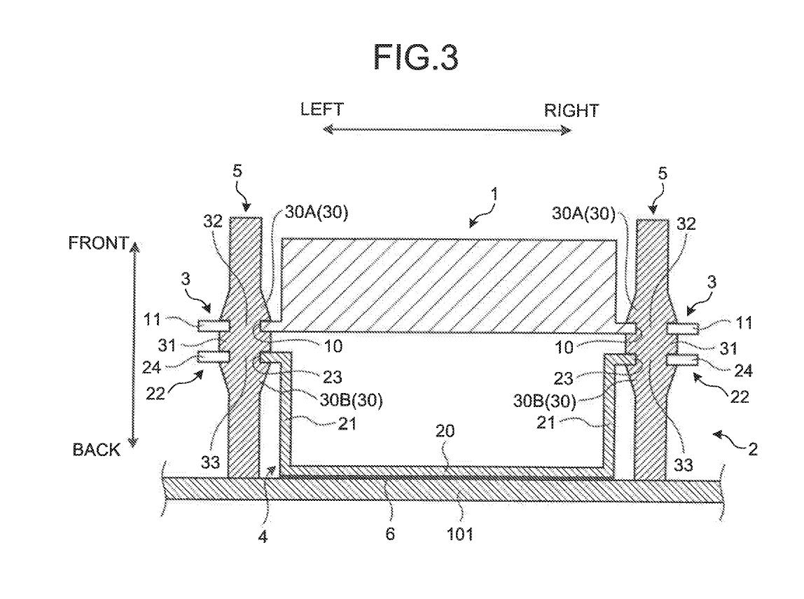

As illustrated in FIGS. 2 and 3, the pump 1 is attached to the rear hatch 101 by using an attachment device 2. FIG. 2 is schematic diagram illustrating a part of the inside of the rear hatch 101 as viewed from the front. FIG. 3 is a cross-sectional view of FIG. 2 taken along a line III-III.

Hereinafter, a left side viewed from a driver's seat of the advancing vehicle 100 is defined as “left” and a right side is defined as “right”. The vertical direction is defined as “down” and a direction reverse to the vertical direction is defined as “up”.

The attachment device 2 includes attachment parts 3, a bracket 4, and elastic members 5.

The attachment parts 3 are arranged on end portions of the pump 1 in a left-and-right direction. The attachment parts 3 may be integrally provided to the pump 1, or may be separately provided from the pump 1.

In each of the attachment parts 3, a first hole 10 and a first slot 11 are formed. A first penetrating part 32 of each of the elastic members 5 penetrates through the corresponding first hole 10. The first slot 11 is communicated with the first hole 10 and extends in the left or right direction. A width (length in up-and-down direction) of the first slot 11 is smaller than the diameters of the first hole 10 and the first penetrating part 32 that penetrates through the first hole 10.

The first slot 11 formed in the attachment part 3 (hereinafter, may be referred to as “left attachment part 3”) that is arranged on the left side of the pump 1 extends in the left direction from the corresponding first hole 10.

The first slot 11 formed in the attachment part 3 (hereinafter, may be referred to as “right attachment part 3”) that is arranged on the right side of the pump 1 extends in the right direction from the corresponding first hole 10.

The bracket 4 is erected on the rear hatch 101. As illustrated in FIG. 3, the bracket 4 is formed in a substantially U-shape in plan view. The bracket 4 includes a bottom part 20, leg parts 21, and reception parts 22. The leg parts 21 extend in the front direction from the left and right end portions of the bottom part 20, and are erected from the rear hatch 101. The reception parts 22 extend in the respective left and right directions from front end portions of the leg parts 21.

The bottom part 20 is attached to the rear hatch 101 by using a double sided tape 6 that is an adhesive member. In other words, the attachment device 2 (pump 1) is attached to the rear hatch 101 by using the double sided tape 6. The bottom part 20 may be attached to the rear hatch 101 by using an adhesive member such as adhesive agent.

Each of the reception parts 22 is continuously formed with the corresponding leg part 21. The reception parts 22 are substantially parallel to the rear hatch 101. In each of the reception parts 22, a second hole 23 and a second slot 24 are formed. The elastic members 5 penetrate through the respective second holes 23. The second slots 24 are communicated with the respective second holes 23, and extend in the respective left and right directions. A width (length in up-and-down direction) of each of the second slots 24 is smaller than the diameter of the corresponding second hole 23 and the diameter of a second penetrating part 33 of the corresponding elastic member 5 that penetrates through the second hole 23.

The reception part 22 (hereinafter, may be referred to as “left reception part 22”) that is provided in the leg part 21 on the left side extends from the corresponding leg part 21 in the left direction so as to face the left attachment part 3. The second slot 24 formed in the left reception part 22 extends from the corresponding second hole 23 in the left direction.

The reception part 22 (hereinafter, may be referred to as “right reception part 22”) that is provided in the leg part 21 on the right side extends from the corresponding leg part 21 in the right direction so as to face the right attachment part 3. The second slot 24 formed in the right reception part 22 extends from the corresponding second hole 23 in the right direction.

The second holes 23 are formed to be coaxial with the respective first holes 10 when positions of the attachment parts 3 are aligned with a position of the bracket 4. The second slots 24 are formed in accordance with respective shapes of the facing first slots 11 and extend in the same directions as those of the facing first slots 11 so that the elastic members 5 are able to be respectively inserted from the left and right directions when positions of the attachment parts 3 are aligned with a position of the bracket 4.

The bracket 4 is fastened with the attachment parts 3 by using the elastic members 5 so as to support the pump 1. The bracket 4 is formed in a substantially U-shape, a space is formed between the pump 1 and the bottom part 20, and thus the attachment structure of the driving apparatus is hollow.

The elastic members 5 are made with the use of an elastic material such as rubber. Each of the elastic members 5 is a substantially rod-shaped member whose cross section perpendicular to the front-and-back direction is formed in a circle shape. The elastic members 5 extend in the front-and-back direction. Back-side ends of the elastic members 5 extend toward the rear hatch 101 and are close to the rear hatch 101 to be in contact with the rear hatch 101. The elastic members 5 are elastically compressed between the respective reception parts 22 and the rear hatch 101. The elastic members 5 penetrates through the respective first holes 10 of the attachment parts 3 and the respective second holes 23 of the bracket 4 so as to fasten the attachment parts 3 and the bracket 4. Specifically, the elastic members 5 fasten the respective attachment parts 3 and the reception parts 22 of the bracket 4 that are opposite to a part of the bracket 4 in contact with the rear hatch 101. Here, the case is exemplified that the four elastic members 5 of the attachment device 2 fasten the attachment parts 3 and the bracket 4; however, not limited thereto.

Each of the elastic members 5 includes a holding part 30, a spacing part 31, the first penetrating part 32, and the second penetrating part 33.

The holding part 30 includes a first holding part 30A and a second holding part 30B. The first holding part 30A is arranged ahead (in front-and-back direction) of the attachment part 3, and is in contact with a front surface of the attachment part 3. The second holding part 30B is arranged behind (in front-and-back direction) the reception part 22, and is in contact with a back surface of the reception part 22. In other words, each of the elastic members 5 holds the corresponding attachment part 3 and the corresponding reception part 22 by using the first holding part 30A and the second holding part 30B so as to fasten the corresponding attachment part 3 (pump 1) and the bracket 4.

The first holding part 30A is formed so that the diameter of the first holding part 30A is larger as a position goes further toward the back from the front, in other words, as the position is closer to the attachment part 3. A back surface of the first holding part 30A is in contact with a front surface of the attachment part 3.

The second holding part 30B is formed so that the diameter of the second holding part 30B is larger as the position goes further toward the front from the back, in other words, as a position is closer to the reception part 22. A front surface of the second holding part 30B is in contact with a back surface of the reception part 22.

The spacing part 31 is formed between the attachment part 3 and the reception part 22. In other words, the elastic member 5 separates the attachment part 3 from the reception part 22. The diameter of the spacing part 31 is larger than the diameter of the first hole 10 and the diameter of the second hole 23. A front surface of the spacing part 31 is in contact with a back surface of the attachment part 3. A back surface of the spacing part 31 is in contact with a front surface of the reception part 22.

The first penetrating part 32 is formed between the first holding part 30A and the spacing part 31. The first penetrating part 32 penetrates through the first hole 10. The diameter of the first penetrating part 32 is slightly larger than that of the first hole 10. Thus, when penetrating through the first hole 10, the first penetrating part 32 is elastically deformed so as to cohere to the first hole 10.

The length of the first penetrating part 32 in the front-and-back direction is slightly smaller than the length of the first hole 10 in the front-and-back direction. Thus, both of the first holding part 30A and the spacing part 31 cohere to the attachment part 3.

The second penetrating part 33 is formed between the second holding part 30B and the spacing part 31. The second penetrating part 33 penetrates through the second hole 23. The diameter of the second penetrating part 33 is slightly larger than the second hole 23. Thus, when penetrating through the second hole 23, the second penetrating part 33 is elastically deformed so as to cohere to the second hole 23.

The length of the second penetrating part 33 in the front-and-back direction is slightly smaller than the length of the reception part 22 in the front-and-back direction. Thus, both of the second holding part 30B and the spacing part 31 cohere to the reception part 22.

When the attachment parts 3 and the bracket 4 are fastened with each other, alignment is performed so that the first holes 10 of the attachment parts 3 and the respective second holes 23 of the reception parts 22 are substantially coaxial, and then the elastic members 5 are inserted, in the left-and-right direction, into the first slots 11 and the second slots 24 while elastically deforming the elastic members 5. The elastic members 5 are inserted to the first holes 10 and the second holes 23. Thus, each of the elastic members 5 fastens the corresponding attachment part 3 and the bracket 4 in a state where the back-side end of the corresponding elastic member 5 is in contact with the rear hatch 101.

Next, functions and effects of the attachment structure of the driving apparatus according to the present embodiment will be explained.

When the driving apparatus is driven, vibration is generated due to the drive of the driving apparatus. When the pump 1 is driven to blow compressed air in a lens of the back camera 103, a hitting vibration occurs.

The vibration generated by the pump 1 is transmitted to the attachment parts 3. In the attachment structure of the driving apparatus, at least parts of the elastic members 5 are arranged between the respective attachment parts 3 and the bracket 4, and ends of the elastic members 5 are in contact with the rear hatch 101, so that it is possible to suppress transmission of the vibration from the attachment parts 3 to the bracket 4. In other words, it is possible to attenuate the vibration that is transmitted to the bracket 4 and the rear hatch 101.

In the attachment structure of the driving apparatus, the elastic members 5 fasten the attachment parts 3 and the bracket 4 without using any screw, bolt, and nut. Specifically, the holding parts 30 of the elastic members 5 hold and fasten the attachment parts 3 and the reception parts 22 while separating the attachment parts 3 and the reception parts 22 so as to interpose the spacing parts 31 between the attachment parts 3 and the reception parts 22. Thus, it is possible to suppress the transmission of the vibration from the attachment parts 3 to the bracket 4, and further possible to attenuate the vibration that is transmitted to the bracket 4 and the rear hatch 101.

The bracket 4 includes the leg parts 21 and the reception parts 22 to be formed in a substantially U-shape. Thus, when the pump 1 is attached to the rear hatch 101 while interposing the bracket 4 therebetween, a space is formed between the pump 1 and the bottom part 20 of the bracket 4. Thus, direct transmission of vibration of the pump 1 to the rear hatch 101 is able to be prevented, so that it is possible to suppress the transmission of the vibration to the rear hatch 101.

Moreover, in the attachment structure of the driving apparatus, the back-side ends of the substantially-rod-shaped elastic members 5 extend toward the rear hatch 101 to be in contact with the rear hatch 101. The elastic members 5 are elastically compressed between the respective reception parts 22 and the rear hatch 101. Thus, even when the attenuated vibration is transmitted to the rear hatch 101 via the bracket 4, the elastic members 5, which are in contact with the rear hatch 101, are able to attenuate the vibration transmitted to the rear hatch 101, so that it is possible to suppress vibration of the rear hatch 101.

As described above, the attachment structure of the driving apparatus is capable of suppressing occurrence of an abnormal noise that is due to the vibration of the rear hatch 101.

In the attachment structure of the driving apparatus, the elastic members 5 fasten the attachment parts 3 and the respective reception parts 22 with each other to be able to attenuate the vibration transmitted to the bracket 4 by using the spacing parts 31, so that it is possible to suppress the vibration transmitted to the rear hatch 101. Thus, it is possible to reduce the number of components and further to reduce the cost.

Furthermore, in the attachment structure of the driving apparatus, the first slots 11 are formed in the attachment parts 3, which are communicated with the respective first holes 10, and the second slots 24 are formed in the reception parts 22, which are communicated with the respective second hole 23 to extend in the same direction as those of the facing first slots 11. Thus, the elastic members 5 are able to easily penetrate through the first holes 10 and the second holes 23, so that it is possible to ease assembling operation and further to improve the workability.

Furthermore, in the attachment structure of the driving apparatus, the width of each of the first slots 11 is smaller than the diameter of the corresponding first penetrating part 32 of the elastic member 5. Thus, it is possible to prevent each of the first penetrating parts 32, which penetrates through the corresponding first hole 10, from being detached from the corresponding first hole 10. Moreover, the width of each of the second slots 24 is smaller than the diameter of the second penetrating part 33 of the corresponding elastic member 5. Thus, it is possible to prevent each of the second penetrating parts 33, which penetrates through the corresponding second hole 23, from being detached from the corresponding second hole 23.

Next, modifications of the attachment structure of the driving apparatus according to the first embodiment will be explained.

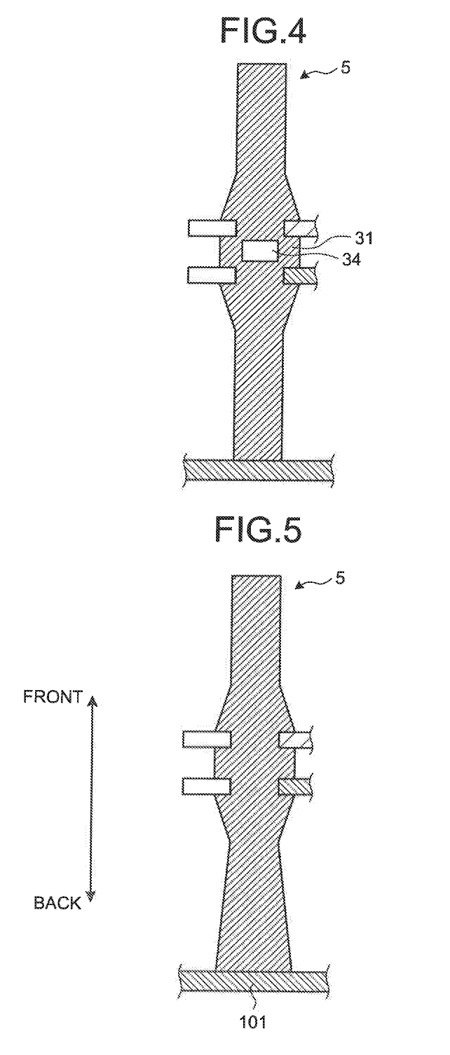

As illustrated in FIG. 4, an attachment structure of the driving apparatus according to a modification is provided with a hollow part 34 in the elastic member 5. FIG. 4 is a schematic cross-sectional view illustrating a part of the attachment structure of the driving apparatus according to the modification. Thus, the transmission of vibration generated by the pump 1 to the rear hatch 101 is able to be prevented more reliably, so that it is possible to suppress occurrence of an abnormal noise.

Furthermore, as illustrated in FIG. 5, in an attachment structure of the driving apparatus according to a modification, the diameter of a back-side portion of the elastic member 5 may be larger as a position goes further toward the back from the front so that an area of a portion in contact with the rear hatch 101 is large. FIG. 5 is a schematic cross-sectional view illustrating a part of an attachment structure of the driving apparatus according to a modification. However, not limited thereto, it is sufficient that the contact area with the rear hatch 101 is large, and the back ends of the two elastic members 5 that are arranged in the up-and-down direction may be connected with each other by using a connector, for example. Thus, the vibration of the rear hatch 101 is able to be suppressed more reliably, so that it is possible to suppress occurrence of an abnormal noise.

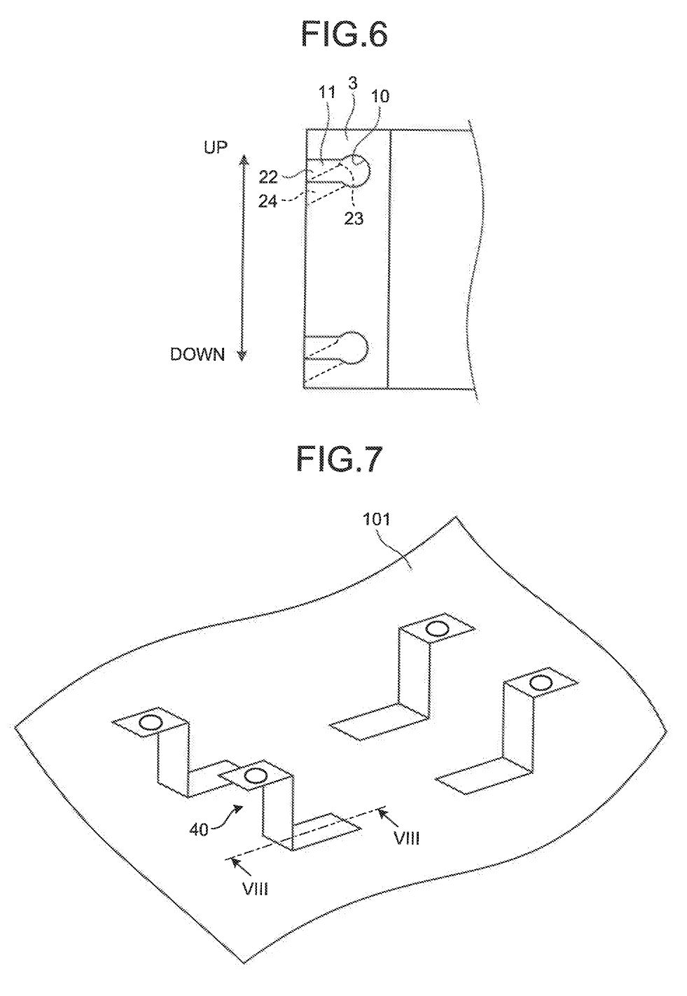

Furthermore, as illustrated in FIG. 6, in an attachment structure of the driving apparatus according to a modification, the first slot 11 and the second slot 24 may be arranged by shifting their positions in the up-and-down direction. FIG. 6 is a schematic diagram illustrating a part of the attachment structure of the driving apparatus according to the modification. In the driving apparatus of the attachment structure according to the present modification, the elastic member 5 (see FIG. 3) is inserted into the first slot 11 and the second slot 24 in a state where an opening of this first slot 11 and an opening of this second slot 24 coincide with each other, for example. The elastic member 5 is penetrated to the first hole 10 and the second hole 23 while relatively sliding the attachment part 3 and the reception part 22 in the up-and-down direction. Thus, it is possible to prevent each of the elastic members 5 from being detached from the corresponding first hole 10 or the corresponding second hole 23 after the elastic members 5 have fastened the attachment parts 3 and the reception parts 22.

Furthermore, in an attachment structure of the driving apparatus according to a modification, only the first holes 10 and the second holes 23 may be provided without providing the first slots 11 and the second slots 24. In this case, each of the elastic member 5 is pulled in the front-and-back direction while elastically deforming the first holding part 30A and the second holding part 30B of the corresponding elastic member 5 in the radial direction, so as to penetrate through the corresponding first hole 10 or the corresponding second hole 23, and the attachment parts 3 and the reception parts 22 are fastened with each other by using the elastic members 5. Thus, it is possible to prevent each of the elastic members 5 from being detached from the corresponding first hole 10 or the corresponding second hole 23 after the elastic members 5 have fastened the attachment parts 3 and the reception parts 22.

In an attachment structure of the driving apparatus according to a modification, the first holding part 30A may be formed so that the diameter of the first holding part 30A is larger as a position goes further toward the front from the back, for example, and the second holding part 30B may be formed so that the diameter of the second holding part 30B is larger as a position goes further toward the back from the front, for example. In other words, a shape of the holding part 30 is not limited to any of those described in the above-mentioned embodiment, it is sufficient that the attachment part 3 and the reception part 22 are held.

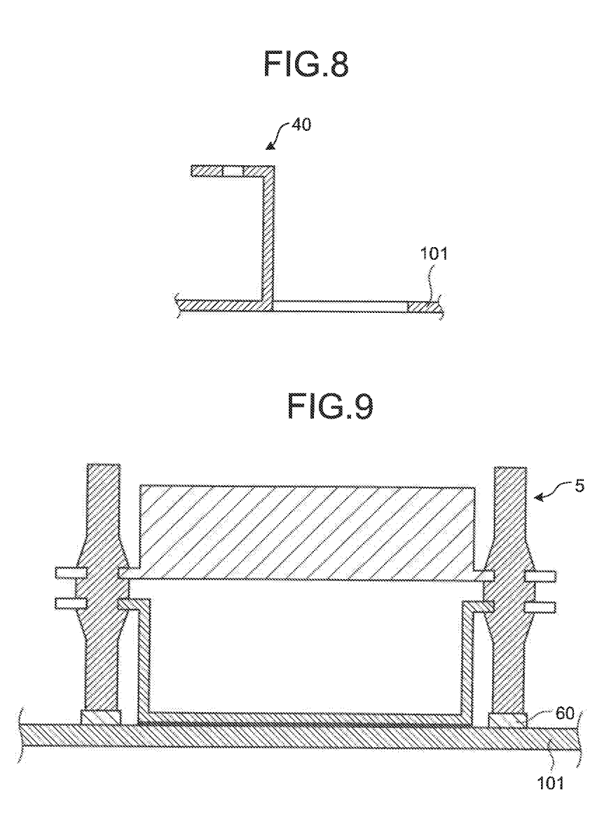

As illustrated in FIGS. 7 and 8, in an attachment structure of the driving apparatus according to a modification, brackets 40 may be integrally formed with the rear hatch 101. FIG. 7 is a schematic perspective view illustrating the brackets 40 used in the attachment structure of the driving apparatus according to the modification. FIG. 8 is a cross-sectional view of FIG. 7 taken along a line VIII-VIII. For example, the brackets 40 are formed by cutting and raising a plate of the rear hatch 101.

Furthermore, as illustrated in FIG. 9, in an attachment structure of the driving apparatus according to a modification, spacers 60 are arranged between the respective elastic members 5 and the rear hatch 101 so that the elastic members 5 are in contact with the rear hatch 101 via the spacers 60. In other words, the contact between the elastic members 5 and the rear hatch 101 includes contact via another member such as the spacer(s) 60. FIG. 9 is a cross-sectional view illustrating the driving apparatus according to the modification.

### Second Embodiment

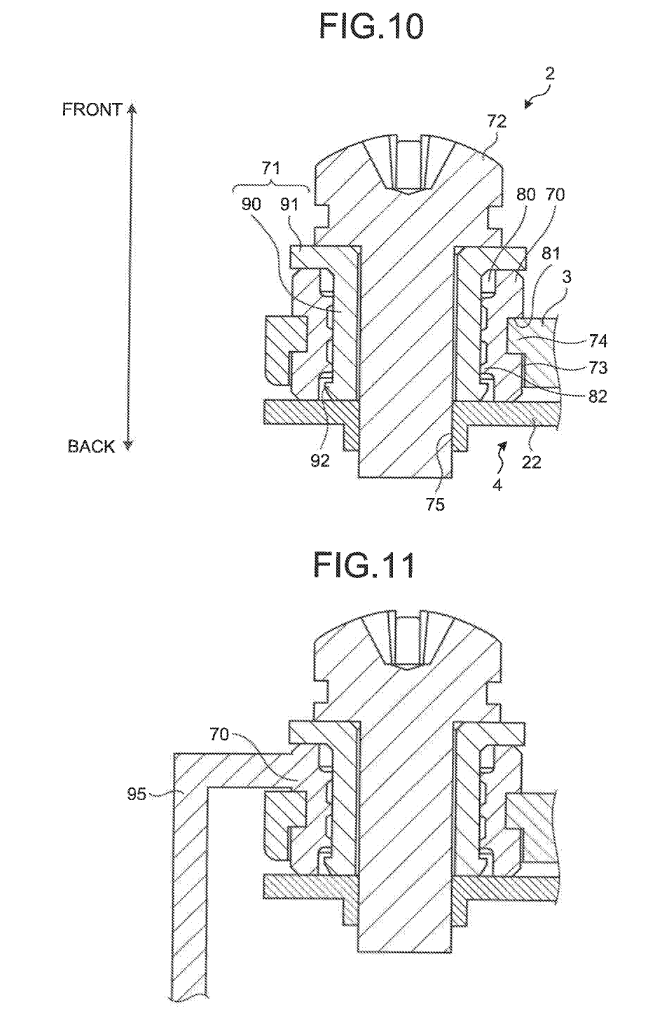

Next, an attachment structure of a driving apparatus according to a second embodiment will be explained with reference to FIG. 10. Note that in the following, a part different from the first embodiment will be mainly described, and the common parts are represented with same symbols and the description is omitted appropriately. FIG. 10 is an enlarged cross-sectional view illustrating a part of the attachment structure of the driving apparatus according to the second embodiment.

The attachment device 2 includes the attachment parts 3, the bracket 4, elastic members 70, and sleeves 71. The attachment device 2 attaches the attachment parts 3 (namely, pump 1: see FIG. 3) to the bracket 4 by using screws 72.

In each of the attachment parts 3, a hole 73 is formed. In the attachment parts 3 according to the second embodiment, the first slots 11 (see FIG. 2) according to the first embodiment are not provided. On an inner periphery wall of the hole 73, a protruding part 74 is formed that protrudes in an inward radial direction of the hole 73.

In each of the reception parts 22 of the bracket 4, a screw hole 75 to which the screw 72 is attached is formed. In the reception parts 22 according to the second embodiment, the second slots 24 (see FIG. 2) according to the first embodiment are not formed.

The elastic members 70 are made with the use of an elastic material such as rubber. Each of the elastic members 70 is provided with a hole 80 into which the sleeve 71 is inserted, to be formed in a cylindrical shape. On an outer periphery wall of the elastic member 70, a groove 81 is formed, and on an inner periphery wall of the elastic member 70, protruding parts 82 are formed.

The groove 81 is formed over the whole circumference of the outer periphery wall. The protruding part 74 of the attachment part 3 is engaged with the groove 81. The number of the grooves 81 and/or the number of the protruding parts 74 of the attachment parts 3 may be two or more.

The protruding parts 82 are formed over the whole circumference of the inner periphery wall. The three protruding parts 82 are aligned side by side along the front-and-back direction. Here, the three protruding parts 82 are exemplified; however, the number of the protruding parts 82 is not limited thereto, and maybe one, for example. The protruding parts 82 are in contact with the sleeve 71.

The elastic member 70 is held, with respect to its radial direction, by the protruding part 74 of the attachment part 3 and a cylinder part 90 of the sleeve 71, and is held, with respect to the front-and-back direction, by a flange 91 of the sleeve 71 and the bracket 4.

Each of the sleeves 71 includes the cylinder part 90 and the flange 91. The sleeve 71 prevents the elastic member 70 from being detached form the attachment part 3 during conveyance in a state where the elastic member 70 is attached to the attachment part 3 and during an attaching operation. The sleeve 71 configures a pressing part.

The cylinder part 90 is inserted into the hole 80 of the elastic member 70, and is in contact with the protruding parts 82 of the elastic member 70. An outside diameter of the cylinder part 90 is larger than inside diameters of the protruding parts 82 of the elastic member 70. Thus, when the cylinder part 90 is inserted into the hole 80 of the elastic member 70, the cylinder part 90 pushes the elastic member 70 toward the attachment part 3. Thus, deflection in the inward radial direction of the elastic member 70 is prevented, so that it is possible to suppress occurrence of play in the radial direction of the elastic member 70.

The cylinder part 90 includes, in a distal end portion thereof, specifically, a distal end thereof close to the bracket 4, a claw part 92 that protrudes in an outward radial direction of the cylinder part 90. The claw part 92 is formed over the whole circumference of the cylinder part 90. The claw part 92 is able to be engaged with the protruding part 82 of the elastic member 70 with respect to a detaching direction of the sleeve 71 from the elastic member 70.

A gap is formed between the claw part 92 and the protruding part 82 with respect to the front-and-back direction. The gap is formed in consideration of a dimensional error between the protruding part 82 and the claw part 92. Thus, when the sleeve 71 is inserted into the hole 80 of the elastic member 70, the claw part 92 is inserted closer to the bracket 4 than the protruding parts 82.

The claw part 92 prevents the sleeve 71 from being detached from the elastic member 70 during conveyance in a state where the sleeve 71 is inserted into the elastic member 70 and during an attaching operation, for example.

The flange 91 is formed in another distal end that is opposite to the distal end of the cylinder part 90 in which the claw part 92 is formed. The flange 91 is in contact with the elastic member 70 so as to hold the elastic member 70 along with the bracket 4, and prevents the elastic member 70 from being detached from the attachment part 3.

The flange 91 protrudes from the cylinder part 90 in an outward radial direction of the cylinder part 90. An outside diameter of the flange 91 is equal to or more than an outside diameter of the elastic member 70. The flange 91 prevents the elastic member 70 from deforming due to a worker's contact with the elastic members 70 during an attaching operation, and further prevents the elastic member 70 from being detached from the attachment part 3.

The sleeve 71 is formed so that a length between the flange 91 and the bracket 4 is smaller than that of the elastic member 70. Thus, the flange 91 compresses the elastic member 70 in the front-and-back direction along with the bracket 4, so that it is possible to suppress occurrence of play in the front-and-back direction of the elastic member 70.

In the attachment structure of the driving apparatus, when the sleeve 71 is inserted into the elastic member 70, the protruding parts 82 of the elastic member 70 and the sleeve 71 are in contact with one another so as to press the elastic member 70 toward the attachment part 3. Thus, the attachment part 3 and the elastic member 70 are in contact with each other, vibration of the motor is accordingly able to be attenuated by using the elastic member 70, so that it is possible to suppress transmission of the vibration to the rear hatch 101. Moreover, it is possible to prevent the elastic member 70 from being detached from the attachment part 3 during conveyance in a state where the elastic member 70 is attached to the attachment part 3 and during an attaching operation.

In the attachment structure of the driving apparatus, the claw part 92 is provided, which is able to be engaged with the protruding part 82 of the elastic members 70 with respect to the direction for detaching the sleeve 71 from the elastic member 70. Thus, it is possible to prevent the sleeve 71 from being detached from the elastic member 70 during conveyance in a state where the sleeve 71 is inserted into the elastic member 70 and during an attaching operation.

The attachment structure of the driving apparatus includes the flange 91 that holds the elastic member 70 with respect to the front-and-back direction along with the bracket 4. Thus, it is possible to prevent a worker from accessing the elastic member 70 during an attaching operation, and further prevent the elastic member 70 from being detached from the attachment part 3. The flange 91 and the bracket 4 hold the elastic member 70 so as to suppress transmission of vibration of the motor to the bracket 4, so that it is possible to suppress transmission of the vibration to the rear hatch 101.

Next, a modification of the attachment structure of the driving apparatus according to the second embodiment will be explained.

As illustrated in FIG. 11, in the attachment structure of the driving apparatus according to the modification, an L-shaped leg part 95 may be provided to the elastic member 70, and a distal end of the leg part 95 may be in contact with the rear hatch 101 (see FIG. 3). FIG. 11 is a cross-sectional view illustrating the attachment structure of the driving apparatus according to the modification.

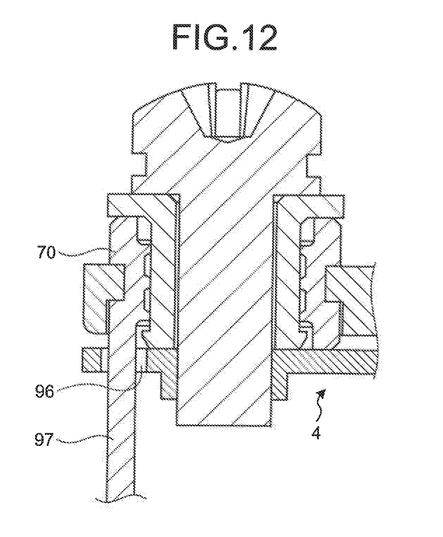

Furthermore, as illustrated in FIG. 12, in an attachment structure of the driving apparatus according to a modification, the bracket 4 may be provided with a hole 96, and a leg part 97 extending from a part of the elastic member 70 may be inserted into the hole 96 so that a distal end of the leg part 97 is in contact with the rear hatch 101 (see FIG. 3). Note that the number of the holes 96 and/or the number of the leg parts 97 may be two or more. FIG. 12 is a cross-sectional view illustrating the attachment structure of the driving apparatus according to the modification.

Thus, the vibration generated by the pump 1, which is transmitted to the rear hatch 101, is able to be suppressed, so that it is possible to suppress occurrence of an abnormal noise.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An attachment structure of a driving apparatus, the structure comprising:
an attachment part that is provided in the driving apparatus;
a bracket that is erected on an attached member; and
an elastic member whose end close to the attached member is in contact with the attached member, at least a part of the elastic member being arranged between the attachment part and the bracket.

2. The attachment structure of the driving apparatus according to claim 1, wherein
the elastic member fastens the attachment part and a side of the bracket, the side being opposite to a side of the bracket that is in contact with the attached member.

3. The attachment structure of the driving apparatus according to claim 1, wherein
the elastic member is formed in a substantially rod shape, and penetrates through the attachment part and the bracket to fasten the attachment part and the bracket, and
the end of the elastic member, which is close to the attached member, extends toward the attached member to be in contact with the attached member.

4. The attachment structure of the driving apparatus according to claim 1, wherein
the bracket includes:
a leg part that is erected from the attached member; and
a reception part that is continuously formed with the leg part and is substantially parallel to the attached member, and
the elastic member penetrates through the attachment part and the reception part to fasten the attachment part and the bracket.

5. The attachment structure of the driving apparatus according to claim 4, wherein
the elastic member is in contact with the attached member while being elastically compressed between the reception part and the attached member.

6. The attachment structure of the driving apparatus according to claim 1, wherein
the elastic member fastens the attachment part and the bracket in a state where the attachment part and the bracket are separated from each other.

7. The attachment structure of the driving apparatus according to claim 6, wherein
the elastic member includes a spacing part between the attachment part and the bracket.

8. The attachment structure of the driving apparatus according to claim 1, wherein
the attachment part includes a first hole through which the elastic member penetrates,
the bracket includes a second hole through which the elastic member penetrates, and
the elastic member includes a holding part that holds the attachment part and the bracket with respect to axial directions of the first and second holes.

9. The attachment structure of the driving apparatus according to claim 8, wherein
the attachment part further includes a first slot that is communicated with the first hole, and
the bracket further includes a second slot that is communicated with the second hole, the second slot extending in a same direction as the first slot that is facing the second slot.

10. The attachment structure of the driving apparatus according to claim 9, wherein
a width of the first slot is smaller than a diameter of the elastic member that is inserted into the first hole.

11. The attachment structure of the driving apparatus according to claim 9, wherein
a width of the second slot is smaller than a diameter of the elastic member that is inserted into the second hole.

12. The attachment structure of the driving apparatus according to claim 1, the structure further comprising:
a pressing part that is inserted into the elastic member to press the elastic member toward the attachment part.

13. The attachment structure of the driving apparatus according to claim 12, wherein
the pressing part includes a flange that holds the elastic member along with the bracket.

14. The attachment structure of the driving apparatus according to claim 12, wherein
a protruding part is formed on an inner periphery wall of a hole of the elastic member into which the pressing part is inserted, the protruding part protruding in an inward radial direction of the hole, and
the pressing part includes a claw part that is able to be engaged with the protruding part with respect to a detaching direction of the pressing part from the elastic member.

15. The attachment structure of the driving apparatus according to claim 1, wherein
the driving apparatus includes a pump that supplies compressed air so as to remove an extraneous matter adhered to a lens of a camera provided in a vehicle.
